(19) United States
(12) Patent Application Publication
(10) Pub. No.: US 2026/0216788 A1
(43) Pub. Date: Jul. 30, 2026

(54) Method and Apparatus for Manufacturing Air Permeable Porous Structures

(71) Applicant: Volta Energy Inc., Toronto (CA)

(72) Inventors: Yifei Yan, Toronto (CA); Olivera Kesler, Toronto (CA)

(21) Appl. No.: 19/181,572

(22) Filed: Apr. 17, 2025

Related U.S. Application Data
(60) Provisional application No. 63/750,871, filed on Jan. 29, 2025.

(51) Int. Cl. B22F 3/22; B22F 3/11; H01M 8/0232

(52) U.S. Cl. CPC B22F 3/22; B22F 3/11; H01M 8/0232; B22F 2202/05; B22F 2301/35

(57) ABSTRACT

A magnetic slip casting method and apparatus for manufacturing air permeable porous structures are disclosed. A first step in the magnetic slip casting method includes combining scaffold forming particles and pore former particles in a liquid to form a slurry. The slurry is then poured into a slip-casting mold and placed in the magnetic slip casting apparatus, which in a preferred embodiment of the invention includes two parallel magnets between which the slurry-containing slip-casting mold is placed. The magnetic field produced by the two parallel magnets and passing through the slurry causes the particles in the slurry to disperse and magnetically assemble into a slurry having an aligned porosity. While maintaining the aligned porosity the slurry is then dried to form a green tape, and the green tape is then fired and sintered to form a final rigid porous structure with the desired aligned porosity.

### CROSS-REFERENCE TO RELATED APPLICATIONS

This application claims the benefit of U.S. Provisional Application No. 63/750,871, filed January 29, 2025.

### BACKGROUND OF THE INVENTION

Solid oxide fuel cells (SOFCs) are a class of fuel cells that utilize an ion-conducting solid-oxide electrolyte, typically yttria-stabilized zirconia (YSZ), to generate electricity. As illustrated in FIG. 1, during operation oxygen O₂ (e.g., from the surrounding air) is reduced at the fuel cell’s 100’s cathode 102, creating negatively-charged oxygen ions O²⁻ that migrate through the solid-oxide electrolyte 104 to the anode 106, where they oxidize hydrogen gas H₂ (which may be produced from an accompanying natural gas, biogas, or other hydrocarbon-based fuel reformer, for example). Oxidizing the hydrogen gas H₂ creates water vapor (H₂O) as a byproduct and electrons (e⁻) that flow through an external circuit 108 as electrical current for powering a load 110. In most applications, many SOFCs 100 are connected in series (often referred to as an “SOFC stack”) so that the resulting power plant is able to produce sufficient output wattage to power the load 110, which may be, for example, an electric vehicle or the electrical power grid, yet without increasing the current that flows through the SOFCs.

SOFCs have great promise, especially given their ability to operate using a wide variety of fuel types, including renewable energy fuels like biogas. They are also attractive due to their high electrical efficiencies. However, there are various obstacles that still must be overcome before they can be commercialized on a larger scale. High material and fabrication costs and lack of robustness are some of the primary obstacles that impede their more widespread commercialization.

One approach that has been proposed to overcome these obstacles involves using a gas permeable stainless steel (SS) substrate 202 (see FIG. 2) to provide mechanical strength and support for the SOFC and plasma spray technology to form the three functional layers of the SOFC (i.e., the cathode 102, solid-oxide electrolyte 104, and anode 106) on the stainless steel substrate 202. Stainless steel is inexpensive and ductile. Moreover, the SS-supported SOFC 200 provides better thermal shock resistance than ceramic-supported SOFCs and the SS substrate 202 has a thermal expansion coefficient similar to YSZ—both of which are important since SOFCs operate at high temperatures (typically somewhere within the range of 600ºC to 1,000ºC) and are often exposed to thermal cycling. Finally, the use of plasma spray technology allows the three functional layers 102, 104, 106 of the SS-supported SOFC 200 to be formed in a matter of minutes, compared to the hours or even days that are usually needed when using more conventional fabrication approaches.

All of the various advantages gained by using a stainless steel substrate and forming the SS-supported SOFC’s 200’s three functional layers 102, 104 and 106 using plasma spray technology make the widespread commercialization of SOFCs more feasible. However, a significant problem remains and that problem is how best to manufacture the stainless steel substrate 202 itself. Although the stainless steel substrate 202 is gas permeable it nevertheless poses a barrier to gas transport, impeding transport of the input fuel reactant to the anode 106. So it is crucial for the manufacturing method to be capable of producing a stainless steel substrate having a high gas permeability. However, the gas permeability should not be made so high that it compromises the structural integrity of the final stainless steel substrate product, and should not render the final stainless steel substrate product overly-susceptible to oxidation and chromium poisoning, which can lead to electrode degradation. Finally, in order to exploit the benefits of plasma spray technology, the manufacturing method should be capable of producing a stainless steel substrate having a microstructure and surface morphology that are compatible with plasma spraying. The present invention addresses and provides solutions to these problems.

### BRIEF SUMMARY OF THE INVENTION

A magnetic slip casting method and apparatus for manufacturing air permeable porous structures are disclosed. A first step in the magnetic slip casting method includes combining scaffold forming particles and pore former particles in a liquid to form a slurry. The slurry is then poured into a slip-casting mold and placed in the magnetic slip casting apparatus, which in a preferred embodiment of the invention includes two parallel magnets between which the slurry-containing slip-casting mold is placed. The magnetic field that is produced by the two parallel magnets and that passes through the slurry causes the particles in the slurry to disperse and magnetically assemble into a slurry having an aligned porosity. While maintaining the aligned porosity the slurry is then dried to form a green tape, and the green tape is then fired and sintered to form a final rigid porous structure with the desired aligned porosity.

The magnetic slip casting apparatus and magnetic slip casting method of the present invention have various advantages over prior approaches to manufacturing porous structures. For example, the overall manufacturing time is much shorter than freeze-drying, and the manufacturing apparatus does not require a continuous supply of electrical power.

The magnetic slip casting method and apparatus of the present invention are particularly well-suited for manufacturing porous stainless steel (SS) substrates for SOFCs, and the SS-substates that are produced advantageously have a microstructure, surface morphology, and open porosity compatible with plasma spray technology. Yet application of the method and apparatus are not limited to the manufacture of SS substrates for SOFCs; they can be easily modified and adapted to manufacture other porous structures—metallic or non-metallic—for other types of devices such as catalyst supports, electrolyzers, and oxygen separation membranes, for example.

Further features and advantages of the invention, including a detailed description of the above-summarized and other exemplary embodiments of the invention, will now be described in detail with respect to the accompanying drawings, in which like reference numbers are used to indicate identical or functionally similar elements.

### BRIEF DESCRIPTION OF THE DRAWINGS

FIG. 1 is sectional view of a solid oxide fuel cell (SOFC), highlighting its various layers and operational characteristics;

FIG. 2 is a sectional view of a stainless-steel (SS)-supported SOFC;

FIG. 3 is sectional view of a magnetic slip casting apparatus according to one embodiment of the present invention;

FIG. 4A is a graph showing the computer-simulated magnetic vector field that passes through the centerline of the slip-casting mold plane of the magnetic slip casting apparatus depicted in FIG. 3 for a circumstance where two parallel magnets are used (i.e., as in FIG. 3);

FIG. 4B is a graph showing the computer-simulated magnetic vector field that passes through the centerline of the slip-casting mold plane of the magnetic slip casting apparatus depicted in FIG. 3 for a circumstance where only a single magnet is used;

FIG. 5A is a graph showing the computer-simulated magnetic field density produced by the two parallel magnets of the magnetic slip casting apparatus depicted in FIG. 3, midway between the two parallel magnets and along a horizontal line of a vertical plane that cuts through the centerlines of the two parallel magnets, for a circumstance where the vertical gap between the two parallel magnets is 38 mm;

FIG. 5B is a graph showing the computer-simulated magnetic field density produced by the two parallel magnets of the magnetic slip casting apparatus depicted in FIG. 3, midway between the two parallel magnets and along a horizontal line of a vertical plane that cuts through the centerlines of the two parallel magnets, for a circumstance where the vertical gap between the two parallel magnets is 19 mm;

FIG. 6A is a flowchart highlighting the slurry preparation process of the magnetic slip casting method of the present invention;

FIG. 6B is a flowchart highlighting the magnetic alignment process of the magnetic slip casting method of the present invention;

FIG. 6C is a flowchart highlighting the tape drying process of the magnetic slip casting method of the present invention; and

FIG. 6D is a flowchart highlighting the firing and sintering processes of the magnetic slip casting method of the present invention.

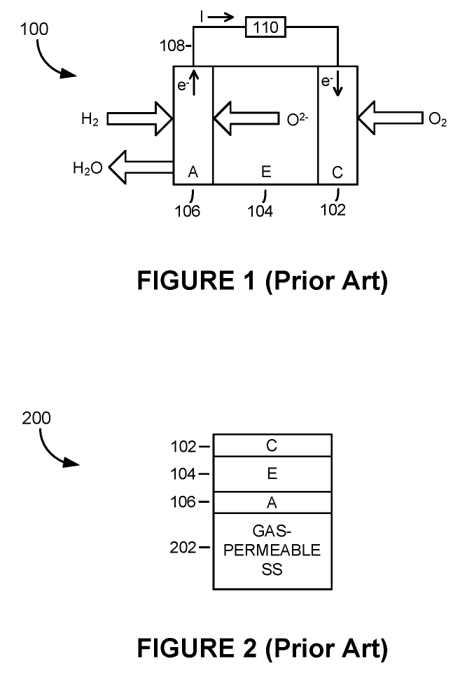

### DETAILED DESCRIPTION

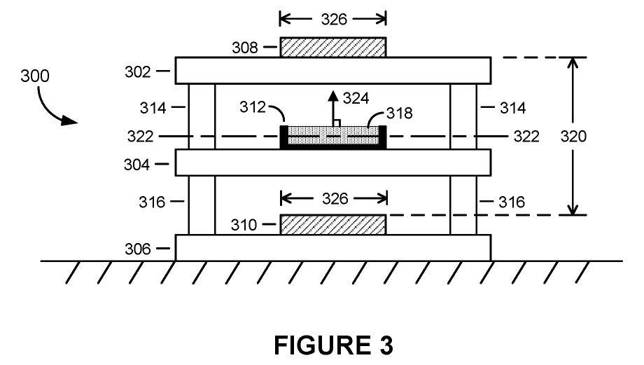

Referring to FIG. 3, there is shown a cross-sectional view of a magnetic slip casting apparatus 300 according to one embodiment of the present invention. The magnetic slip casting apparatus 300 is well-suited for manufacturing air-permeable porous stainless steel substrates upon which the three functional layers of an SOFC (i.e., the anode, cathode and solid-oxide electrolyte) can then be formed, preferably using an atmospheric plasma spray process. However, the magnetic slip casting apparatus 300 and the magnetic slip casting method 600 described in detail below can also be used to manufacture other porous structures for other types of devices, such as catalyst supports, electrolyzers, and oxygen separation membranes, for example.

In general, and as shown in FIG. 3, the magnetic slip casting apparatus 300 comprises a top plate 302, a center plate 304, a bottom plate 306, first and second parallel permanent magnets 308 and 310, and a removable slip-casting mold 312. The first permanent magnet 308 is held by and supported by the top plate 302, the second permanent magnet 310 is held by and supported by the bottom plate 306 (or on a workbench surface instead of using the bottom plate 306), and the slip-casting mold 312 is held and supported by the center plate 304. Spacers 314 provide support and spacing between the top plate 302 and center plate 304, and spacers 316 provide support and spacing between the center plate 304 and the bottom plate 306. It should be noted that although it is possible to use two electromagnets, i.e., rather than the two parallel permanent magnets 308 and 310, using the two permanent magnets is preferred since, among other advantages, their use avoids having to generate large electrical currents to energize the electromagnets.

In one embodiment of the invention spacers 314 and 316 are adjustable, thereby allowing the vertical spacing between the top of the center plate 304 and the bottom of the top plate 302 and the vertical spacing between the bottom of the center plate 304 and the top of the bottom plate 306 to be independently adjusted for any given application. The ability to adjust the spacers 314 and 316 allows the slip-casting mold 312 and slurry 318 (i.e. “slip” 318) held within it to be positioned in an optimal vertical position with respect to the first and second parallel permanent magnets 308 and 310. In particular, and as can be important in many applications, the adjustability affords the ability to set an optimal ratio of gap size 320 to magnet diameter 326, thus ensuring that the magnetic field produced by the first and second parallel permanent magnets 308 and 310 passes through the slurry 318 uniformly and with the desired intensity. For purposes of this disclosure, the magnetic field is considered to be “uniform” when the magnetic field passes through the slip-casting mold 312 and slurry/slip 318 in a slip-casting mold plane 322 at angles no greater than 20 degrees from the normal 324 of the slip-casting mold plane 322 and the slip magnetic flux density through the slurry/slip 318 in the slip-casting mold plane 322 deviates from a mean slip magnetic flux density by no more than 20%.

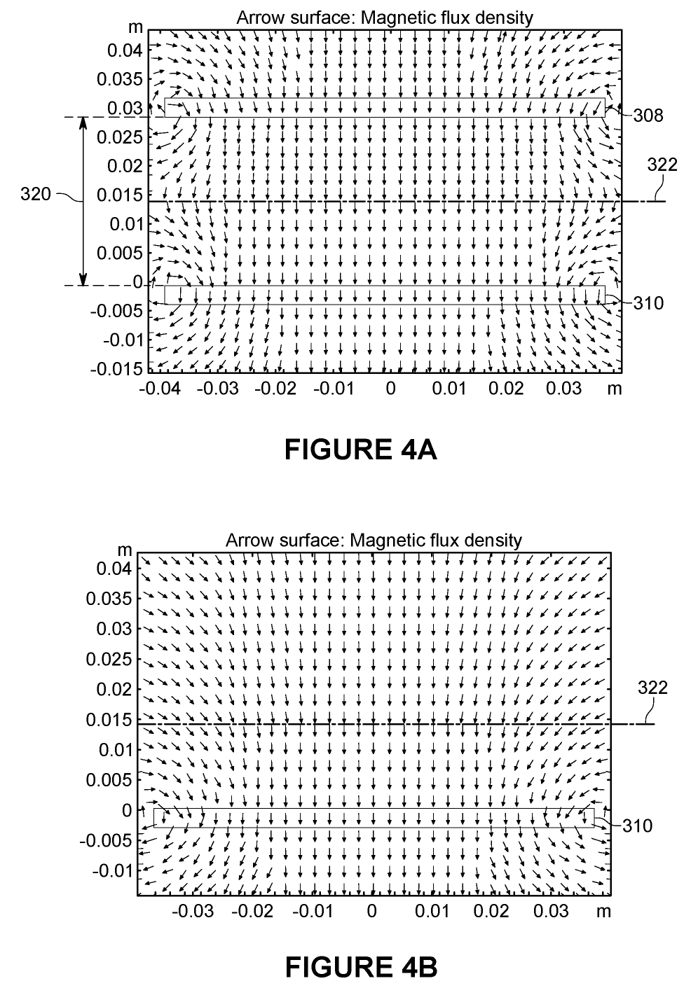

It should be mentioned although the magnetic slip casting apparatus 300 preferably uses two parallel magnets (i.e., first and second parallel permanent magnets 308 and 310), in some applications a single magnet may be sufficient. In such a single-magnet approach the single magnet should have a sufficient strength and size so that when positioned relative to the slip-casting mold 312 the magnetic field produced by the single magnet passes through the slurry 318 uniformly and in accordance with the two criteria specified above (magnetic field passes through the slip-casting mold 312 and slurry/slip 318 in a slip-casting mold plane 322 at angles no greater than 20 degrees from the normal 324 of the slip-casting mold plane 322 and the slip magnetic flux density through the slurry/slip 318 in the slip-casting mold plane 322 deviates from a mean slip magnetic flux density by no more than 20%). Because these two criteria cannot always be satisfied using just a single magnet, however, in most applications the two-parallel-magnet approach depicted in FIG. 3 is preferred. One difficulty in using just a single magnet relates to the extent the magnetic field produced by just the single magnet can be made uniform in the slip-casting mold plane 322. As can be seen in FIGS. 4A and 4B, which are magnetic vector field simulations of the two approaches, the magnetic field passing through the slip-casting mold plane 322 can be made uniform over a significantly larger area when two parallel magnets are used (FIG. 4A) compared to when just a single magnet is used (FIG. 4B).

In one embodiment of the invention the first and second permanent magnets 308 and 310 comprise first and second N52 grade neodymium disc magnets, and spacers 314 and 316 are adjusted so that the ratio of gap size 320 to diameter 326 of the N52 permanent magnets is within a range of (inclusive) 0.25 and 0.6. Satisfying this ratio ensures that when the N52 neodymium disc magnets are used to manufacture air-permeable porous stainless steel substrates suitable for SOFCs, using the magnetic slip casting method 600 described below, the magnetic field passes through the slurry 318 and slip-casting mold 312 uniformly and the final porous stainless steel product produced by application of the method 600 has the desired aligned porosity.

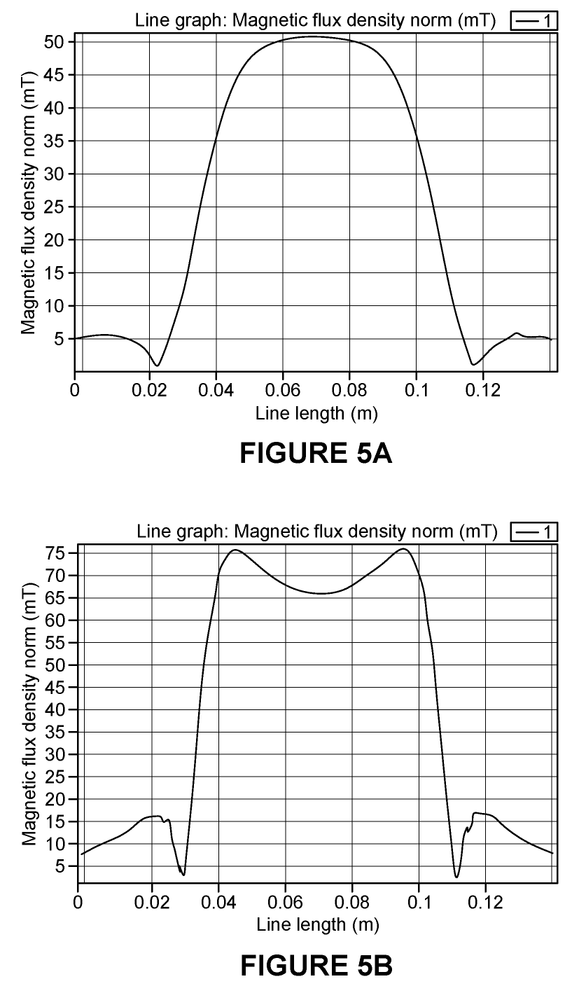

Because the ability to pass the magnetic field uniformly through the slurry 318 and slip-casting mold 312 depends on the type and grade of permanent magnet but the optimal ratio of gap size 320 to diameter 326 of the two parallel magnets may differ depending on the type and grade of magnet used, the ability to adjust the gap size by adjusting the spacers 314 and 316 is crucial. The magnetic flux density measurements shown in FIGS. 5A and 5B highlight the importance of being able to adjust and control the gap size 320 in an application in which two N52 grade neodymium disc magnets are used. The magnetic flux density measurements shown in FIG. 5A are for a gap size 320 of 38 mm, and the magnetic flux density measurements shown in FIG. 5B are for a gap size 320 of 19 mm. The dip in the magnetic flux density measurements (FIG. 5B) indicates that the gap size 320 of 19 mm may be too narrow for the magnetic field to be sufficiently uniform in the slip-casting mold plane 322. On the other hand, although the peak of the magnetic flux density in FIG. 5A is perhaps sufficiently uniform, the areal extent of its uniformity in the slip-casting mode plane 322 is small and, depending on the lateral dimensions of the slip-casting mold 312 may be insufficient to fully cover the slip 318 in the slip-casting mold plane 322. Consequently, if the “uniform” magnetic field requirements specified above (magnetic field passes through the slip-casting mold 312 and slurry/slip 318 in a slip-casting mold plane 322 at angles no greater than 20 degrees from the normal 324 of the slip-casting mold plane 322 and the slip magnetic flux density through the slurry/slip 318 in the slip-casting mold plane 322 deviates from a mean slip magnetic flux density by no more than 20%) an acceptable compromise between the two might be to adjust the spacers 314 and 316 so that the gap size 320 is somewhere between 38 mm and 19 mm, say 30 mm, for example.

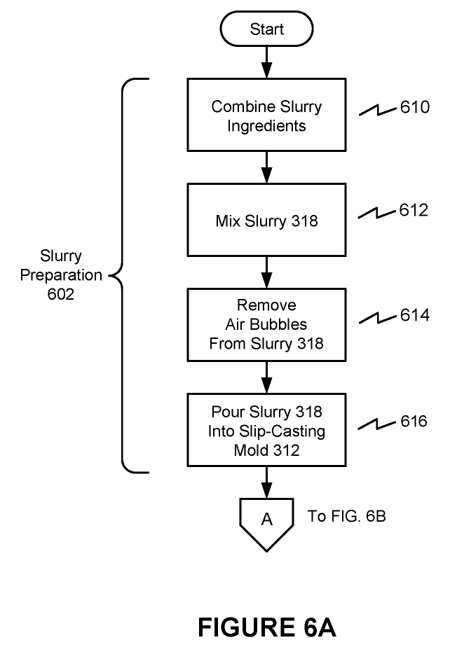

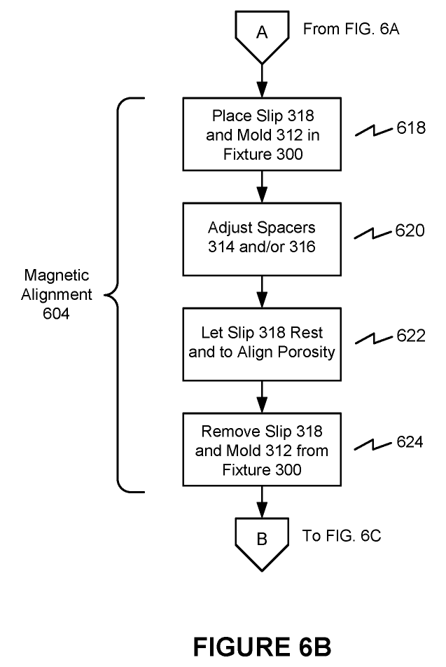

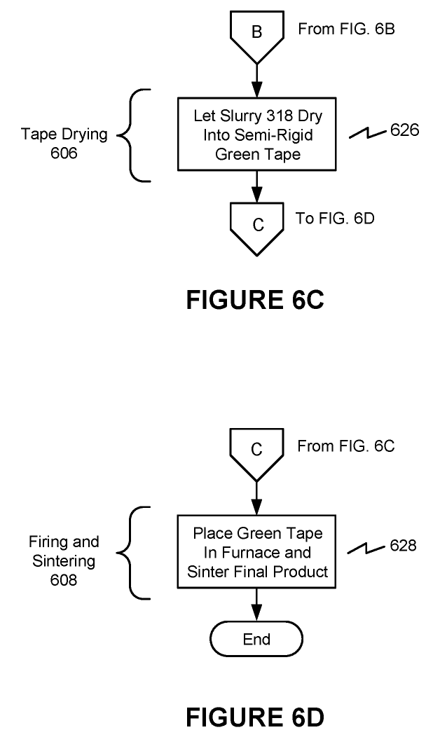

FIGS. 6A-6D are flowcharts depicting a magnetic slip casting method according to one embodiment of the present invention. The magnetic slip casting method 600 utilizes a magnetic slip casting apparatus similar to the magnetic slip casting apparatus 300 depicted in FIG. 3 (or a single-magnet variation thereof), and in general comprises: a slurry preparing process 602 (FIG. 6A), a magnetic alignment process 604 (FIG. 6B), a tape drying process 606 (FIG. 6C), and a final firing and sintering process 608 (FIG. 6D). Each of the various processes 602, 604, 606 and 608 in the overall manufacturing method 600 are described in detail below.

First, in first step 610 of the slurry preparing process 602 (see FIG. 6A), the slurry 318 ingredients, including magnetic scaffold forming particles, pore former particles, binder, thickener, and solvent are combined in a mixing vessel. Then, in step 612, the slurry 318 ingredients are mixed using, for example a ball miller or a vibration miller, to form the desired slurry 318 (i.e., “slip 318”). The solid loading of the slip 318 is preferably within the range (inclusive) of 10-40% by volume. A solid loading toward the lower limit of the range is desirable since it allows the greatest freedom of movement of solid particles during the magnetic alignment process 604. On the other hand a solid loading toward the upper end of the range is desirable since it helps ensure that the aligned porosity achieved during the magnetic alignment process 604 is maintained even after the magnetic alignment process 604 is completed and throughout the drying process 606.

In one embodiment of the invention in which the magnetic slip casting method 600 is employed to manufacture air-permeable porous stainless steel substrates for SOFCs, the magnetic scaffold forming particles are derived from 430L stainless steel powder and the pore former particles comprise acrylic glass beads (i.e., polymethyl methacrylate (PMMA) glass beads). Other types of magnetic scaffold forming particles can be used, but for SOFC applications 430 stainless steel is preferred due to its combined low cost and relatively high chromium content (16 wt. % to 18 wt. %). Different types of pore former materials can also be used, such as starch, for example.

The liquid used to make the slurry 318 can be water but may alternatively be an organic-based solvent. The advantage of an organic-based solvent is that it allows the slip 318 to dry faster during the tape drying process 606 (FIG. 6C), whereas an aqueous slip 318 has the advantages of being nonflammable and non-toxic.

In one embodiment of the invention the magnetic scaffold forming particles have a mean particle size between 10 and 40 μm, the ratio of pore former particle size (D₅₀ by volume) to scaffold particle size (D₅₀ by volume) is 1:4 or less, and the volume fraction of pore former particles in the slip 318 relative to the entire volume of solid particles in the slip 318 is within the range of (inclusive) 0.1 to 0.7. With this combination of attributes, propensity of cracking during the tape drying process 606 is minimized. This same combination of attributes also helps ensure that the aligned porosity attained by application of the magnetic alignment process 604 continues to be maintained after the magnetic alignment process 604 has completed and throughout the tape drying process 606.

After the mixing step 612 is completed, in step 614 air bubbles are removed from the slurry 318 by placing the slurry 318 in a vacuum chamber and using a vacuum pump or by other suitable degassing means. To facilitate air bubble removal the slurry 318 may be diluted but in circumstances where the magnetic slip casting method 600 is used to manufacture air-permeable porous stainless steel substrates for SOFCs it is preferable that the viscosity of the slurry 318 be kept within a range of (inclusive) 0.1 pascal-seconds (Pa·s) to 1.0 Pa·s.

Once the slip 318 has been mixed and the air bubbles removed, in step 616 the slip 318 is poured from the mixing vessel into the slip-casting mold 312, in preparation of the magnetic alignment process 604 described next.

In first step 618 of the magnetic alignment process 604 (see FIG. 6B) the slurry-containing slip-casting mold 312 is placed and centered upon the center plate 304 of the magnetic slip casting apparatus 300. Then, in step 620 (which may be alternatively performed before step 618) spacers 314 and/or 316 are adjusted so that the vertical separations between the top of the center plate 304 and bottom of the top plate 302 and between the bottom of the center plate 304 and top of the bottom plate 306 are of the desired or required distance. In embodiments of the invention in which the first and second parallel permanent magnets 308 and 310 comprise first and second N52 grade neodymium disc magnets and the magnetic slip casting apparatus 300 and magnetic slip casting method 600 are used to manufacture air-permeable porous stainless steel substrates for SOFCs, the spacers 314 and 316 are preferably adjusted so that the ratio of the gap size 320 to diameter 326 of the N52 magnets is within a range of (inclusive) 0.25 and 0.6. With this adjustment the magnetic field produced by the two parallel N52 grade neodymium disc magnets is sure to pass uniformly through the slip 318 in the slip-casting mold plane 322. The magnetic vector field simulation result shown in FIG. 4A and the magnetic flux density measurements shown in FIG. 5A reveal and indicate that the slip-casting mold 312 is optimally positioned for this particular application when the slip-casting mold plane 322 is adjusted and set so that it is equidistant from the bottom of first magnet 308 and top of second permanent magnet 310, and the gap size 320 is ~30 mm. Although these dimensions and distances are not required for all applications, experiments have confirmed that they are optimal for manufacturing air-permeable porous stainless steel substrates for SOFCs when N52 grade neodymium disc magnets are used for the first and second parallel magnets 308 and 310.

After the slip-casting mold 312 has been properly positioned on center plate 304 and the spacers 314 and 316 have been appropriately adjusted, in step 622 the slip 318 is allowed to rest in the uniform magnetic field for a time sufficient to allow the magnetic scaffold forming particles to move under the influence of the magnetic field and the pore former particles to disperse and become aligned in the direction of the magnetic field. In most circumstances 30 minutes is sufficient. Finally, in step 624 the slip 318 and slip-casting mold 312 are removed from the magnetic slip casting apparatus 300.

Next, in step 626 of the tape drying process 606 (see FIG. 6C), the magnetically-aligned slurry 318 held by the slip-casting mold 312 is allowed to dry. In applications in which the magnetic slip casting apparatus 300 and magnetic slip casting method 600 are used to manufacture air-permeable porous stainless steel substrates for SOFCs the temperature of the external environment is preferably maintained at 40ºC. The tape drying process 604 serves to consolidate the powder compact into a semi-rigid green tape. The aligned porosity achieved during the magnetic alignment process 604 is retained in the resulting green tape. It should be mentioned that drying could be alternatively completed with the slurry 318 and slip-casting mold 312 still remaining in the magnetic slip casting apparatus 300. However, in some applications, the green tape has a tendency to crack when drying in the presence of a magnetic field. Therefore, while perhaps not necessary in all circumstances, the tape drying process 606 is preferably performed in the absence of a magnetic field.

Finally, in step 628 of the firing and sintering process 608 (see FIG. 6D), the green tape is placed in a furnace to burn away the pore formers and remove any remaining organic additives. Sintering the green tape has the effect of permanently affixing the aligned porosity and densifying the final porous product to its final desired density. The firing temperature is carefully controlled so that a final rigid product is produced but without disrupting the aligned porosity.

In the exemplary embodiments of the invention described above the scaffold forming particles are described as being magnetic (e.g., derived from 430L stainless steel powder), the pore former particles are described as being nonmagnetic (e.g., acrylic (PMMA) beads), and the final product is described as being magnetic (e.g., a porous ferritic stainless steel substrate). In alternative embodiment of the invention, the scaffold forming particles are nonmagnetic and the pore former particles are magnetic. According to this alternative embodiment of the invention, the method of manufacturing the porous structure is similar to the magnetic slip casting method 600 described above, except that magnetic pore former particles are chemically removed from the green tape to form the final porous structure, rather than during the firing and sintering process 608. Using this alternative embodiment of the invention nonmagnetic porous structures like porous aluminum, for example, can be manufactured.

While various embodiments of the present invention have been described, they have been presented by way of example and not limitation. It will be apparent to persons skilled in the relevant art that various changes in form and detail may be made to the exemplary embodiments without departing from the true spirit and scope of the invention. Accordingly, the scope of the invention should not be limited by the specifics of the exemplary embodiments but, instead, should be determined by the appended claims, including the full scope of equivalents to which such claims are entitled.

1. A magnetic slip casting method for manufacturing porous structures, comprising:
combining scaffold forming particles and pore former particles in a liquid to form a slurry;
pouring the slurry into a slip-casting mold;
positioning the slurry and slip-casting mold within a magnetic field;
magnetically dispersing particles in the slurry using the magnetic field to form a slurry having an aligned porosity;
drying the slurry to form a green tape while preserving the aligned porosity; and
firing and sintering the green tape to form a final rigid porous structure having the aligned porosity.

2. The magnetic slip casting method of claim 1, wherein the magnetic field produced by the one or more magnets passes through the slurry and slip-casting mold in a slip-casting mold plane at angles no greater than 20 degrees from the normal of the slip-casting mold plane.

3. The magnetic slip casting method of claim 2, wherein a slip magnetic flux density through the slurry in the slip-casting mold plane deviates from a mean slip magnetic flux density by no more than 20%.

4. The magnetic slip casting method of claim 1, wherein the pore former particles are magnetic, the scaffold forming particles are nonmagnetic, and the pore former particles are chemically removed prior to firing and sintering.

5. The magnetic slip casting method of claim 1, wherein the scaffold forming particles are magnetic, the pore former particles are nonmagnetic, and the nonmagnetic pore former particles are burned away during firing and sintering.

6. The magnetic slip casting method of claim 1, wherein the magnetic field is produced by just a single permanent magnet.

7. The magnetic slip casting method of claim 1, wherein the magnetic field is produced by first and second parallel permanent magnets and the slurry and slip-casting mold are positioned between the first and second parallel permanent magnets.

8. The magnetic slip casting method of claim 7, wherein the first and second parallel permanent magnets comprise first and second N52 grade neodymium disc magnets.

9. The magnetic slip casting method of claim 8, wherein a ratio L/D of a gap size L to a diameter D of the first and second N52 grade neodymium disc magnets is between 0.25 and 0.6.

10. The magnetic slip casting method of claim 1, wherein drying the slurry is performed in the absence of a magnetic field.

11. The magnetic slip casting method of claim 1, wherein a ratio of pore former particle size to scaffold particle size (D₅₀ by volume) is 1:4 or less.

12. The magnetic slip casting method of claim 1, wherein a volume fraction of pore former particles relative to the entire volume of solid particles in the slurry is within a range of 0.1 to 0.7.

13. The magnetic slip casting method of claim 1, wherein a viscosity of the slurry before drying is within a range of 0.1 pascal-seconds (Pa·s) to 1.0 Pa·s.

14. The magnetic slip casting method of claim 1, wherein a solid loading of the slurry is within a range of 10-40% by volume.

15. The magnetic slip casting method of claim 1, wherein the final rigid porous structure comprises an air-permeable stainless steel substrate suitable for serving as a substrate for a solid oxide fuel cell (SOFC).

16. The magnetic slip casting method of claim 15, wherein the air-permeable stainless steel substrate has a microstructure and surface morphology compatible with plasma spraying.

17. A magnetic slip casting apparatus, comprising:
a slip-casting mold adapted to hold a slip; and
one or more magnets configured so that a magnetic field produced by the one or more magnets during slip casting passes through the slip-casting mold in a slip-casting mold plane at angles no greater than 20 degrees from the normal of the slip-casting mold plane.

18. The magnetic slip casting apparatus of claim 17, wherein during slip casting a slip magnetic flux density through the slip in the slip-casting mold plane deviates from a mean slip magnetic flux density by no more than 20%.

19. The magnetic slip casting apparatus of claim 17, wherein the one or more magnets comprises first and second parallel permanent magnets and the slip and slip-casting mold is positioned between the first and second parallel permanent magnets during slip casting.

20. The magnetic slip casting apparatus of claim 19, further comprising one or more spacers between the first and second parallel permanent magnets that can be adjusted to set and control a gap size between the first and second parallel permanent magnets.

21. The magnetic slip casting apparatus of claim 19, wherein the first and second parallel permanent magnets comprises first and second N52 grade neodymium disc magnets, and a ratio L/D of a gap size L to diameter D of the first and second N52 grade neodymium disc magnets is between 0.25 and 0.6.
